(19) United States
(12) Patent Application Publication
(10) Pub. No.: US 2011/0115450 A1
(43) Pub. Date: May 19, 2011

(54) SYSTEM AND METHOD FOR CONTROLLING START UP OF A VOLTAGE REGULATOR SYSTEM WITH INDEPENDENT VOLTAGE REGULATION

(75) Inventor: Nattorn PONGRATANANUKUL, Sunnyvale, CA (US)

(73) Assignee: INTERSIL AMERICAS INC., MILPITAS, CA (US)

(21) Appl. No.: 12/950,276

(22) Filed: Nov. 19, 2010

Related U.S. Application Data
(60) Provisional application No. 61/262,631, filed on Nov. 19, 2009.

(51) Int. Cl. H02M 3/158

(52) U.S. Cl. 323/271

(57) ABSTRACT

A multichannel voltage regulator includes a plurality of voltage regulator modules for generating a regulated output voltage responsive to an input voltage and a feedback voltage. Synchronization circuitry controls a release of PWM signals during soft start within each of the plurality of voltage regulator modules. The PWM signals release are synchronized to occur substantially at a same point in time.

### CROSS-REFERENCE TO RELATED APPLICATIONS

This application claims priority to U.S. Provisional Application No. 61/262,631, entitled SYSTEM AND METHOD FOR START UP OF VOLTAGE REGULATOR SYSTEM WITH INDEPENDENT REGULATION, filed Nov. 19, 2009, which is incorporated herein by reference.

### BRIEF DESCRIPTION OF THE DRAWINGS

For a more complete understanding, reference is now made to the following description taken in conjunction with the accompanying Drawings in which:

FIG. 1 is a schematic diagram of a buck voltage regulator;

FIG. 2 is a schematic diagram of a multi-channel buck voltage regulator having non-independent voltage regulation;

FIG. 3 is a schematic diagram of a multi-channel buck regulator using independent voltage regulation;

FIG. 4 is a block diagram of a multi-channel voltage regulation system including compensation circuitry for synchronously regulating the buck voltage regulator modules responsive to the output voltage;

FIG. 5 illustrates a first embodiment of the compensation circuitry for regulating the output voltage for the multi-channel voltage regulator;

FIG. 6 illustrates an alternative embodiment for regulating the output voltage of the multi-channel voltage regulator using a common bus approach;

FIG. 7 illustrates a further embodiment for independently regulating the output voltage of the multi-channel voltage regulator; and

FIG. 8 illustrates yet a further embodiment for synchronizing the PWM signals of a multi-channel voltage regulator.

### DETAILED DESCRIPTION

Referring now to the drawings, wherein like reference numbers are used herein to designate like elements throughout, the various views and embodiments of a system and method for controlling start up of a voltage regulator system with independent voltage regulation are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

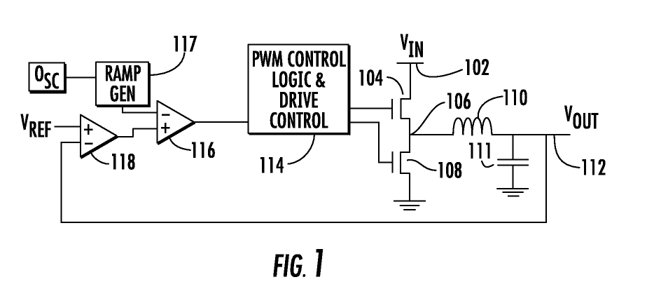

Referring now to the drawings, and more particularly to FIG. 1, there is illustrated a block diagram of a buck regulator module voltage regulation circuit. An input voltage V_{IN} is applied at input voltage node 102. The input voltage V_{IN} is applied across an upper gate switching transistor 104 that has its drain/source path connected between node 102 and a phase node 106. The lower gate switching transistor 108 has its drain/source path connected between phase node 106 and the ground node. An inductor 110 is connected between the phase node 106 and an output voltage node 112. A capacitor 111 is connected between the output voltage node 112 and ground. The output voltage node 112 provides the regulated voltage from the output voltage regulation circuit.

The upper gate switching transistor 104 and the lower gate switching transistor 108 have their gates connected to PWM logic and drive control circuitry 114. The PWM logic and drive control circuitry 114 generate the gate control signals for turning on the upper gate switching transistor 104 and the lower gate switching transistor 108 responsive to the output of a PWM comparator 116. The PWM comparator 116 generates a PWM control signal to the PWM control logic and drive control circuitry 114 responsive to a ramp waveform provided at its inverting input from a ramp generator circuit 117 and a voltage error signal provided to the non-inverting input of the PWM comparator 116. The voltage error signal (COMP signal) is generated at an error amplifier 118. The error amplifier 118 generates the voltage error signal responsive to a reference voltage provided at its non-inverting input and in a feedback output voltage provided from the output voltage node 112 applied to its inverting input.

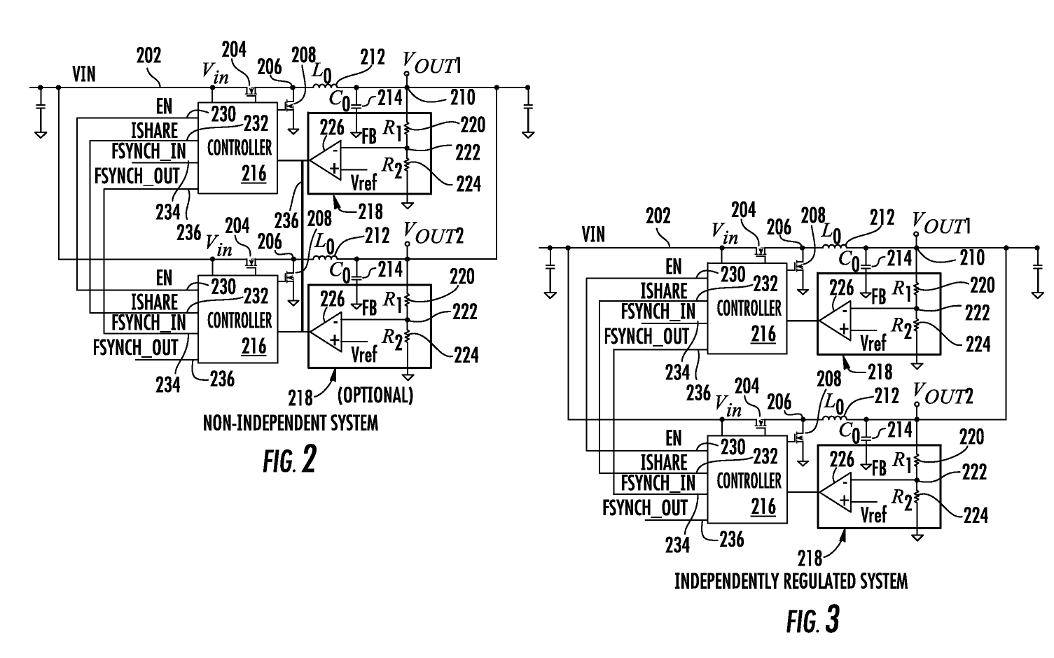

By interconnecting a plurality of buck regulators, as illustrated in FIG. 1, a multi-channel buck voltage regulator as illustrated in FIG. 2 may be implemented. In the multi-channel buck voltage regulator the input voltage V_{IN} is applied to input voltage node 202. An upper gate switching transistor 204 has its drain/source path connected between node 202 and phase node 206. A lower gate switching transistor has its drain/source path connected between phase node 206 and ground. An inductor 212 is connected between phase node 206 and the output voltage node 210. A capacitor 214 is connected between the output voltage node 210 and ground.

The switching control of the upper gate switching transistor 204 and lower gate switching transistor 208 are provided from a PWM controller 216. The PWM controller 216 generates the drive control signals to the gates of transistors 204 and 208 responsive to an error voltage signal provided from an error voltage feedback circuit 218. The error voltage feedback circuit 218 consists of a voltage divider including a resistor 220 connected between node 210 and node 222. The voltage divider includes a second resistor 224 connected between node 222 and ground. An error amplifier 226 has its inverting input (FB pin) connected to node 222 of the voltage divider. The non-inverting input of the error amplifier 226 is connected to a reference voltage V_{REF}. The output of the error amplifier 226 comprises a error voltage (COMP signal) that is applied as a feedback input to the PWM controller 216. Each of the buck voltage regulator modules include the components described herein above. The PWM controllers 216 within a multi-channel buck regulator are interconnected such that they include an enable bus 230 interconnecting the enable pins of the PWM controllers. An ISHARE bus 232 interconnects the ISHARE pins of the PWM controllers 216. An FSYNC_OUT PIN of the PWM controller is connected to an FSYNC_IN input of a second PWM controller. In a non-independent voltage regulator system the outputs of each of the error amplifiers 226 are interconnected via bus 236.

While the following description is made with respect to a multi-channel buck voltage regulator, the below described techniques can be used with other types of voltage regulators.

Referring now to FIG. 3, there is illustrated an independently regulated multi-channel buck regulator. The components of the independently regulated multi-channel buck regulator are the same as those described with the non-independent system. However, the outputs of the error amplifiers 226 are not interconnected via bus 236. An independently regulated system includes separate feedback paths and provides no common interloop connection within the feedback path. Each buck regulator module does not have knowledge of other buck regulator modules. Due to this, differences in component tolerances between channels of the buck regulator system will cause the start up speeds for each of the buck regulators within the separate channels of the multi-channel buck regulator to be different. During soft start processes, a buck regulator IC module increases its reference voltage V_{REF} and monitors the output voltage via the local feedback pin FB at node 222. The output of the error amplifier 226 will begin to rise as the reference voltage increases beyond the feedback voltage applied to the error amplifier. When the error voltage reaches the bottom of the ramp provided by the ramp generation circuit, a PWM signal is generated and released for voltage regulation. Due to component tolerances, the rise of the error voltage and the PWM release time varies between different buck voltage modules

When a buck regulator releases its PWM signal, this will cause an increase in the output voltage. This increase in the output voltage causes other voltage regulators to recognize that the output voltage has already increased and delay the release of their PWM signals further causing their own PWM signals to not be generated until a much later point in time. These differences within the start up time of buck voltage regulator modules within a multi-channel buck regulator system having independent voltage regulation arise because of the differences within the error voltage signals and component tolerance at the outputs of the various error amplifiers on each channel. The channel that releases its PWM signal first will cause the output voltage to rise and the remaining channels will see this as a pre-bias condition. A synchronous converter module that delays its switching until later will sink current as it starts up causing the first module that is already switching to experience an over current event. Thus, a system that does not provide simultaneous start up of its voltage regulation modules cannot supply a load demand greater than that supported by a single module. Thus, some manner for synchronizing the start up of the voltage regulators within a multi-channel buck voltage regulator is needed.

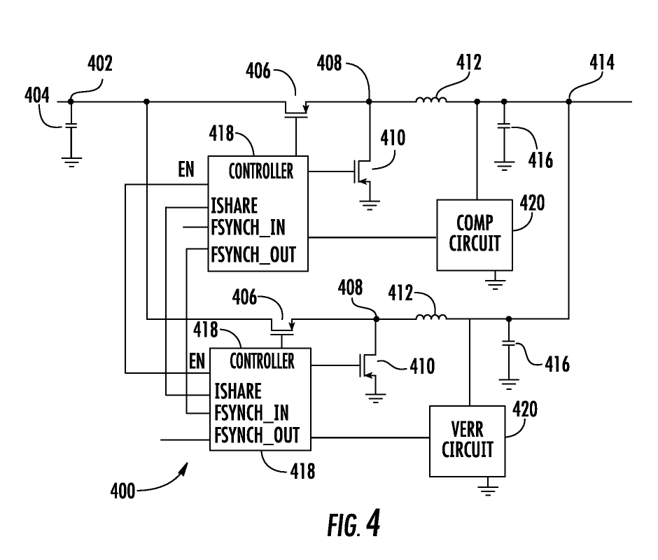

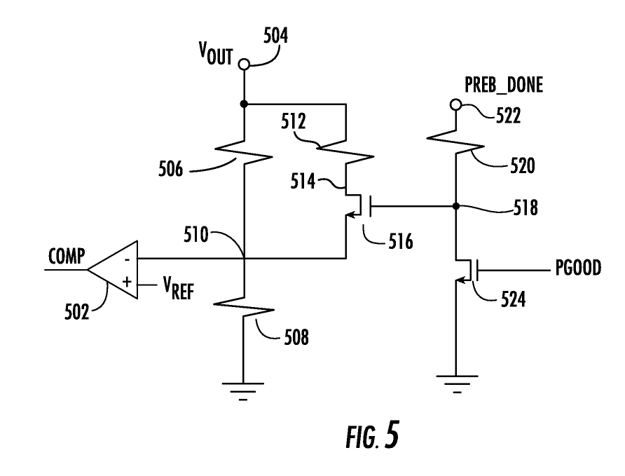

Referring now to FIG. 4, there is illustrated the general configuration of a multi-channel buck regulator circuit. The input voltage V_{IN} is applied at an input voltage node 402. A capacitor 404 is connected between the input voltage node 402 and ground. An upper switching transistor 406 is connected between node 402 and phase node 408. A lower switching transistor has its drain/source path connected between node 408 and ground. Inductor 412 is connected between node 408 and the output voltage node 414. An output capacitor 416 is connected between the output voltage node 414 and ground. The switching control signals for upper switching transistor 406 and lower switching transistor 410 are provided via a PWM controller 418. The PWM controller 418 generates the control signals responsive to a feedback voltage received from a voltage error (VERR) circuit 420 that provides an input to the PWM controller 418 responsive to the output voltage at node 414. Each of the channels of the multi-channel buck voltage regulator includes similar components as those described above. The voltage regulation provided by the voltage error circuit 420 are not interconnected and thus provide independent voltage regulation.

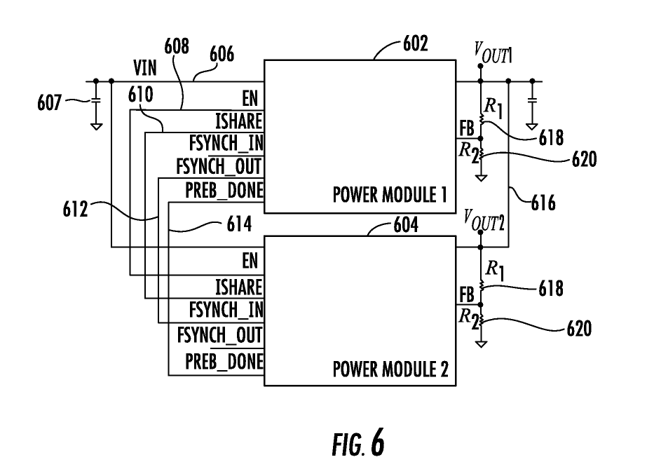

Referring now to FIG. 5, there is illustrated one implementation of the voltage error circuit 420 that provides a solution to the soft start synchronization problem discussed herein above. The output voltage is monitored at node 504 while the error voltage provided to the PWM controller 418 is provided from the output of error amplifier 502. A voltage divider consists of a resistor 506 connected between node 504 and node 510 and a second resistor 508 connected between node 510 and ground. The inverting input of the error amplifier 502 is connected to node 510, and the reference voltage V_{REF} is applied to the non-inverting input of error amplifier 502. A resistor 512 is connected in parallel with resistor 506 between node 504 and node 514. An N-channel switching transistor 516 has its drain/source path connected between node 514 and node 510. While transistors 516 and 524 are illustrated in FIG. 5, any type of ideal switch component may be used.

The gate of transistor 516 is connected to node 518. A resistor 520 is connected between node 518 and node 522 wherein the control signal PREB_DONE from the PWM controller 418 is applied. The PREB_DONE signal indicates the buck regulator module is ready to release its PWM signal. A switching transistor 524 has its drain/source path connected between node 518 and ground. The gate of transistor 524 is connected to receive the control signal P_GOOD from the PWM controller indicating that the internal soft start is complete, the internal reference has reached the target, and the sensed voltage at node 510 is within the desired value.

The circuit of FIG. 5 illustrates a self adjustment approach for controlling the voltage regulator during a soft start. When a voltage regulator is ready to release its PWM signal for regulation, the effective feedback voltage provided from the output of the error amplifier 502 is modified such that it lowers the regulated output voltage and allows other voltage regulator modules to begin regulation targeting a higher voltage output initially. In the circuit of FIG. 5, before a power module is ready to release the PWM signal, the PREB DONE signal is at a logical “low” level and transistor 516 is turned off. The target output voltage provided by the voltage divider consisting of resistors 506 and 508 is unaffected. When the PWM signal is ready to be released by the PWM controller 418, the PREB_DONE signal goes to a logical “high” level, and transistor 514 is turned on. This places resistor 512 in parallel with resistor 506. Thus, the target output voltage monitored at node 504 is lower because of the lower effective high-side resistor 512 being placed in parallel with resistor 506. Other voltage regulator modules including a low PREB_DONE signal will continue to try and regulate to the real target voltage and likely have their reference voltage exceed the feedback voltage. Once the lower regulation voltage level is reached, the P_GOOD control signal provided by the PWM controller 418 is used to turn on transistor 524. This provides a connection to ground for the gate of transistor 516 and turns off transistor 516. This removes the parallel connection between resistor 506 and 512 causing the output voltage to go back to the correct value.

Rather than implementing the change in the effective feedback voltage as illustrated in FIG. 5, alternative methods may also be utilized. These include injecting a current signal proportional to the sensed current during PWM regulation. A power module that does not include any switching action will have a low current and see a relatively lower feedback voltage in response to this. By adjusting the feedback voltage seen at the feedback pin of the error amplifier, this allows other voltage regulator modules to raise their COMP voltage to the level necessary to release their PWM signals. Alternatively, the internal reference voltage Vref can be adjusted to have a similar effect. At the beginning of soft start, each module's internal Vref increases at the same rate. Once a module is ready to release the PWM activity, the rate of change of Vref is reduced. In this way, other modules will attempt to receive a stronger command to regulate to a higher Vref; thus encouraging them to initiate PWM activity. After each module has release their PWM activity, they will increase Vref at the same rate.

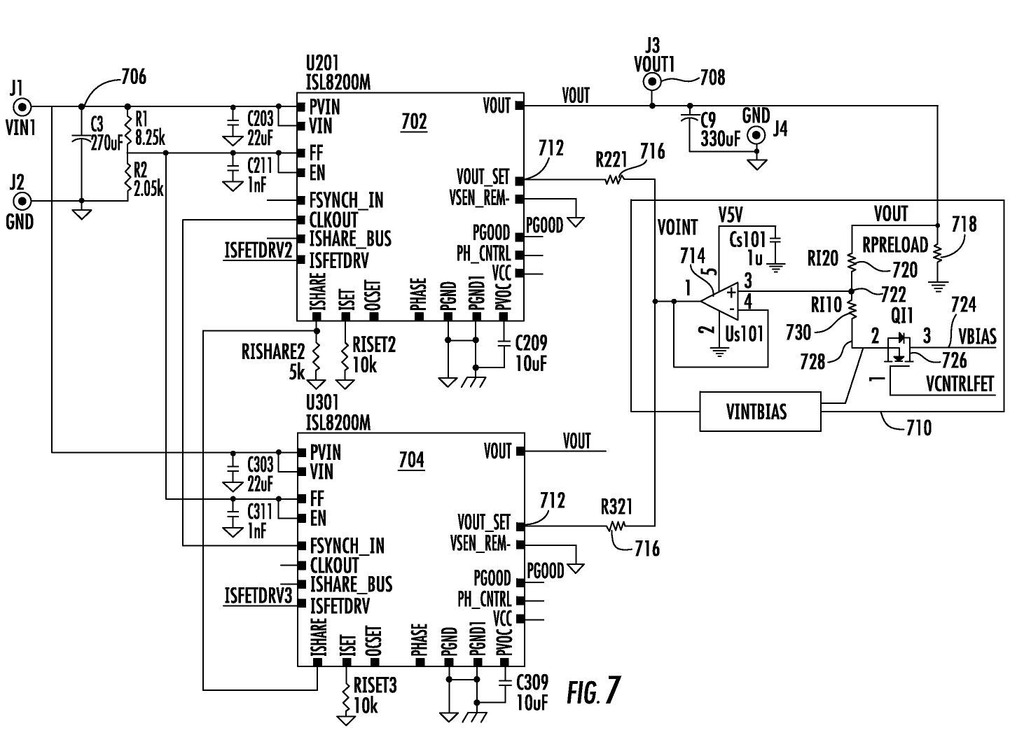

Referring now to FIG. 6, there is illustrated an alternative implementation for synchronizing PWM signal release during a soft start operation of a multi-channel buck voltage regulator. FIG. 6 illustrates a common bus approach wherein a first voltage regulator module 602 is associated with a second voltage regulator module 604. The input voltage is applied via a bus 606. The enable pins of each of the voltage regulator modules 602 and 604 are interconnected via a bus 608. The ISHARE pins are similarly connected via a bus 610. The FSYNC_OUT pin of power module 602 is connected with the FSYNC_IN pin of power module 604 via bus 612. The PREB_DONE pins of each of the modules 302 and 304 are also interconnected via a bus 614. The output pins of each of the modules 602 and 604 are connected via a bus 616. Each of the output pins are also associated with a voltage divider circuit 618 connected to the FB pins of the voltage regulator modules 602 and 604.

Whenever a voltage regulator module within the system is ready to release its PWM signal during soft start, the module will change the state of its PREB_DONE signal. Using the common bus approach, with each of the PREB_DONE signals interconnected via bus 614, each voltage regulator module will monitor the PREB_DONE bus 614. Each module in the system will detect the change in the PREB_DONE signal during start up and will delay the release of their PWM signal, or release the PWM signal at the instant PREB_DONE changes state, until each voltage regulator module has indicated the state of their PREB_DONE signal. This implementation can also be done over new or existing bus lines such as the enable bus 608 or the ISHARE bus 610.

The applicable system includes systems with a reference voltage ramp up profile that is similar or the same. To have a well controlled reference ramp up voltage, the modules within the system will hold the enable signal low until it is ready to regulate the output voltage. With the enable pins interconnected, the enable bus 608 will remain low until every IC is ready to internally release the enable pin from shorting to ground. The ready condition includes completion of supply rails, power on reset, completion of locking to the synchronization frequency and indication of the beginning of soft start. With frequency synchronization, every voltage regulator module has the same timing interval which it will use to increase the reference voltage and delay interval. With discretized steps, the reference voltage and the different modules are stepping up to within certain tolerances of one another. When the ready condition occurs, the enable pin is released and the module will start to increment the reference voltage. By tying the COMP signals together in current mode control, the COMP level is raised based upon the average COMP level of each module.

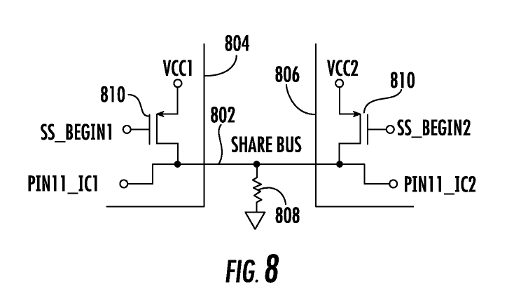

Referring now to FIG. 7, there is illustrated yet another solution for synchronizing release of PWM signals for regulation during soft start for multiple voltage regulator modules 702 and 704. The input voltage V_{IN} is applied at node 706 and the voltage regulators 702 and 704 generate the output voltage at node 708. The voltage regulator modules 702 and 704 include a pre-bias circuit 710 for applying a pre-bias voltage to the feedback inputs 712 of each of the voltage regulators 702 and 704. The pre-bias voltage at the feedback pins 712 maintains a voltage level that allows the voltage regulator modules 702 and 704 to begin regulation with PWM activity at the same time. The feedback voltage is applied from the output of an amplifier 714 in a source follower configuration through an associated resistor 716. The pre-bias circuit 710 connects to the output voltage node 708 and includes a pre load resistor 718 connected between node 708 and ground. The pre load resistor 718 clamps the output voltage to ground. The output voltage V_{OUT} is applied through a resistor 720 connected between node 708 and node 722. A bias voltage VBIAS is applied at node 724. An N-channel transistor 726 has its drain/source path connected between node 724 and node 728. The gate of transistor 726 is connected to receive the P_GOOD control signal from the voltage regulator 702 indicating that the internal reference has reached the target. A resistor 730 is connected between node 722 and node 728. Node 722 sums the value of the output voltage V_{OUT} applied from node 708 and the bias voltage VBIAS applied at node 724 when transistor 726 is turned on.

The value of the pre-bias voltage is established at node 712 to be slightly above the internal Vref (0.6 volts) and during the start up condition when the output voltage is 0 volts, the voltage at node 722 will be equal to VOINT derived from a VBIAS plus 0 volts V_{OUT}. The VOINT voltage is applied to the source follower configured amplifier 714 which outputs a voltage equal to VOINT voltage to the feedback pin 712 of the voltage regulator modules 702 and 704. The pre-bias voltage applied at pin 712 at each of the voltage regulator modules 702 and 704 remains at slightly above target Vref volt during the soft start condition of each of the voltage regulator modules 702 and 704. When the P_GOOD signal from the voltage regulator indicates that the internal soft start condition has been completed, this signal is applied to the gate of transistor 726 to turn off the transistor 726. As the transistor is turned off, the effective voltage applied to the summing node 722 due to VBIAS decreases and becomes insignificant. Due to the closed-loop regulation, the modules will regulate VOUT to maintain VOUTSET at the internal Vref.

Thus, the pre-bias circuit 710 provides a virtual pre-bias condition at each of the feedback pins 712, and node 728 (VINTBIAS) is summed with the output voltage V_{OUT} from node 708 in a closed loop configuration. The P_GOOD signal output from the voltage regulators 702 and 704 goes to a logical “high” level if the voltage at the feedback pin 712 is within a window of Vref (in one example, 9% of 600 millivolts). This causes the signal applied to the gate of transistor 726 to go low causing node 728 to float. The output voltage V_{OUT} will then begin to increase while the VINTBIAS bias voltage decreases.

Referring now to FIG. 8, there is illustrated a further embodiment for synchronizing the release of a PWM signal during soft start. In this case, the ISHARE bus 802 interconnects two pins of a first voltage regulator module 804 and a second voltage regulator module 806. A pull down resistor 808 is connected between the ISHARE bus 802 and ground. A transistor 810 is implemented within each of the voltage modules 804 and 806 such that the source/drain path of the transistor is connected between system power and the ISHARE bus 802. The transistor 810 is implemented within each voltage regulator module 804 and 806. When the soft start process is initiated, the control signal SS_BEGIN# goes to a logical “high” level turning on the transistor and connecting the ISHARE bus to system power. This pulls the ISHARE bus 802 to a high voltage level. When the soft start is ready to begin, the SS_BEGIN# control signal goes to a logical “low” level turning off transistor 810 and disconnecting the ISHARE bus 802 from system power. When each of the transistors 810 have been turned off, the ISHARE bus 802 is no longer connected to system power at any point and the pull down transistor 808 will pull the ISHARE bus 802 to ground. When the ISHARE bus 802 falls to a logical “low” level the soft start process for the multi-channel voltage regulator is started or PWM activity begins. This enables synchronization of release of the associated PWM signals. The ISHARE bus may then be used for its standard function after the soft start process. The ISHARE bus will normally indicate the system output current of all the power modules. However, in this case, it is being used to initiate the beginning and end of the soft start process. Each voltage regulator module monitors and has the ability to change the state of the share bus 802.

Thus, using any of the above described implementations, the soft start process and release of the PWM signals within a multi-channel voltage regulator circuit may be synchronized to better provide control of an independently regulated circuit.

It will be appreciated by those skilled in the art having the benefit of this disclosure that this system and method for controlling start up of a voltage regulator system with independent voltage regulation provides an improved manner for synchronizing PWM signal release during soft start. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A multichannel voltage regulator, comprising:
a plurality of voltage regulator modules for generating a regulated output voltage responsive to an input voltage and a feedback voltage; and
synchronization circuitry for controlling a release of PWM signals during soft start within each of the plurality of voltage regulator modules, wherein the PWM signals release are synchronized to occur substantially at a same point in time.

2. The multichannel voltage regulator of claim 1 further including feedback voltage monitoring circuitry for generating the feedback voltage responsive to the regulated output voltage and a reference voltage.

3. The multichannel voltage regulator of claim 2, wherein the feedback voltage monitoring circuitry comprises a plurality of feedback voltage modules, each associated with one of the plurality of voltage regulator modules, for adjusting an error voltage generated from the feedback voltage, wherein the feedback voltage is provided at a first level upon initiation of soft start and is provided at a second level upon completion of soft start.

4. The multichannel voltage regulator of claim 3, wherein each of the plurality of feedback voltage modules further comprises:
a voltage divider for generating the feedback voltage responsive to the regulated output voltage;
a resistor;
switching circuitry for selectively connecting the resistor in parallel with a portion of the voltage divider to provide a first error voltage upon initiation of soft start and a second error voltage upon completion of soft start.

5. The multichannel voltage regulator of claim 2, wherein the feedback voltage monitoring circuitry comprises a prebias voltage module for applying the feedback voltage to feedback inputs of the plurality of voltage regulator modules, wherein the feedback voltage maintains a constant level during the soft start.

6. The multichannel voltage regulator of claim 5, wherein the prebias voltage module further comprises:
a source follower amplifier having an output connected to the feedback inputs of the plurality of voltage regulator modules for providing a summed voltage at the output;
summing circuitry for combining the regulated output voltage with a bias voltage to generate the summed voltage;
a switch for disconnecting the bias voltage from the summing circuitry responsive to an indication that the soft start has completed.

7. The multichannel voltage regulator of claim 1, wherein the synchronization circuitry further comprises:
a bus interconnecting common pins on each of the plurality of regulator modules;
a resistor connecting the bus to ground; and
a switch associated with each of the plurality of regulator modules for connecting the bus with system power.

8. The multichannel voltage regulator of claim 7, wherein each of the plurality of regulator modules closes the switch within a regulator module to connect the bus to system power at a beginning of the soft start process for the voltage regulator and opens the switch within the regulator module to disconnect the bus from system power at an end of the soft start process, the bus being pulled low to initiate release of PWM signals by the regulator modules after each regulator module disconnects the bus from system power.

9. The multichannel voltage regulator of claim 1, wherein the synchronization circuitry further comprises:
an output pin within each of the plurality of regulator modules for providing an indication of completion of a soft start process of an associated regulator module; and
a bus interconnecting the output pins for each of the plurality of regulator modules.

10. The multichannel voltage regulator of claim 1, wherein each of the plurality of regulator modules provides an indication on the output pin upon completion of the soft start process, each of the regulator modules delaying release of a PWM signal until each of the regulator modules provides an indication of completion of the soft start process on the bus.

11. A method for synchronizing release of PWM signals in a multichannel voltage regulator, comprising the steps of:
controlling a release of PWM signals during soft start within each of the plurality of voltage regulator modules, wherein the PWM signals release are synchronized to occur substantially at a same point in time; and
generating a regulated output voltage responsive to an input voltage and a feedback voltage.

12. The method of claim 11, wherein the step of generating further includes the step of generating the feedback voltage responsive to the regulated output voltage and a reference voltage.

13. The method of claim 12, wherein the step of generating the feedback voltage further comprises the step of adjusting an error voltage generated from the feedback voltage, wherein the feedback voltage is provided at a first level upon initiation of soft start and is provided at a second level upon completion of soft start.

14. The method of claim 13, wherein the step of adjusting the error voltage further comprises the steps of:
generating the feedback voltage at the second level responsive to the regulated output voltage;
connecting a resistor in parallel with a portion of a voltage divider to provide the feedback voltage at the first level upon initiation of soft start and the feedback voltage at the second level upon completion of soft start.

15. The method of claim 12, wherein the step of generating further includes the step of applying the feedback voltage to feedback inputs of the plurality of voltage regulator modules, wherein the feedback voltage maintains a constant level during the soft start.

16. The method of claim 15, wherein the step of applying the feedback voltage further comprises the steps of:
combining the regulated output voltage with a bias voltage to generate a summed voltage during soft start;
providing the summed voltage through a source follower configured amplifier; and
disconnecting the bias voltage responsive to an indication that the soft start has completed.

17. The method of claim 11, wherein the step of controlling further comprises the steps of:
connecting a common bus interconnecting each of the plurality of voltage regulator modules to a system voltage responsive to an associated regulator module initiating a soft start;
disconnecting the common bus within the associated voltage regulator module from system power when the soft start is completed within the associated regulator;
pulling the common bus to ground using a pull down resistor; and
releasing PWM signals from each of the plurality of voltage regulator modules responsive to the common bus being pulled to ground.

18. The method of claim 11, wherein the step of controlling further comprises the steps of:
an output pin within each of the plurality of regulator modules for providing an indication of completion of a soft start process of an associated regulator module; and
interconnecting common output pins for each of the plurality of regulator modules to a bus;
providing an indication on the output pin of each of the plurality of voltage regulator modules upon completion of the soft start at the voltage regulator module; and
delaying release of a PWM signal from each of the voltage regulator modules until each of the voltage regulator modules provides an indication of completion of the soft start process on the bus.
